(19) United States
(12) Patent Application Publication
(10) Pub. No.: US 2005/0103703 A1
(43) Pub. Date: May 19, 2005

(54) Method of assembling a filtration plate

(76) Inventors: Stephen Young, Chicopee, MA (US); Yevgeniy Margolin, Medfield, MA (US)

Correspondence Address: LAHIVE & COCKFIELD, LLP., 28 STATE STREET, BOSTON, MA, 02109, US

(21) Appl. No.: 10/950,125

(22) Filed: Sep. 24, 2004

Related U.S. Application Data
(60) Provisional application No. 60/506,383, filed on Sep. 26, 2003.

(51) Int. Cl. B01D 35/00

(52) U.S. Cl. 210/450; 422/101; 210/435; 435/287.3; 156/60

(57) ABSTRACT

A filtration plate includes an upper plate having one or more wells formed therein, a lower plate having one or more wells corresponding to the wells of the upper plate, a filter media separating the upper plate wells from the lower plate wells, and a seal formed at an interface between the upper plate and the lower plate. A method of assembling the filtration plate comprises applying a seal-promoting material to a component of the filtration plate and curing the seal-promoting material to form the seal at an interface between the upper plate and the lower plate.

### RELATED APPLICATIONS

The present invention claims priority to U.S. Provisional Patent Application Ser. No. 60/506,383 filed Sep. 26, 2003, the contents of which are herein incorporated by reference.

### FIELD OF THE INVENTION

The present invention relates to single or multi-well filtration test plates. More particularly, the present invention relates to a method of assembling a filtration test plate.

### BACKGROUND OF THE INVENTION

Single and multi-well filtration and titration apparatuses are utilized in a variety of biological and chemical and industrial assay procedures, for example, for cell culture, drug discovery research, immunology, and molecular biology, among others. A single, multiwell, or micro-titer test plate includes one or more wells, which are typically used as reaction vessels in which the various assays can be performed. During an assay procedure, a sample can be collected on a filter media within a well for subsequent analysis, or an impurity can be removed from a liquid by being collected on a filter media and the filtrate collected and analyzed. Various methods exist by which the filter media can be maintained in position in the sampling well.

One type of single or multiwell, or micro-titer test plate includes a thermoplastic upper plate having a single or plurality of wells extending through, a filter, and a thermoplastic lower plate for supporting the filter. The lower plate has a single or plurality of apertures arranged to be registerable with the bottoms of the wells in the upper plate. Separation of solids from a fluid medium in a test plate is accomplished by filtration within the wells of the upper plate through the filter. The separation is accomplished in or on the filter by passing the liquid through it. The liquid can be propelled through the filter either by a pressure differential or by centrifugal force.

A significant problem that has been encountered with filter plates in the current state of the art is leakage of a liquid being filtered from the wells, for example, at the interface between the filter media and the wells. Another drawback to current filtration devices and methods of assembling a filtration device include problems with bonding a filter media to a plate. Prior methods of bonding often damage the filter media or the plate, or fail to provide a sufficiently strong bond between the filter media and the plate, leading to leakage, tearing of the filter media or separation of the filter media from the plate.

### SUMMARY OF THE INVENTION

The present invention provides a method for the assembly and production of a single or multiwell filtration plate. The filtration plate may comprise a two-component single or multiwell filter plates designed for the filtration or removal of particles, which includes a seal at an interface between components of the filtration plate. The filtration plate includes an upper plate having one or more wells, a lower plate having one or more wells corresponding to the wells of the upper plate and a filter media separating the upper well or wells from the lower well or wells. One or more rings formed of a seal-promoting material formed at an interface between the upper plate and the lower plate prevent fluid leakage and ensure bonding of the filter media to the upper and/or lower plate.

In another embodiment, sealing between an upper and lower plate of a filtration plate is enhanced using a latching mechanism between the upper and lower plate. For example, one of the upper and lower plate may include one or more raised rings about the circumference of a well, and the other of the upper and lower plate includes a recess about a well, which is configured to receive the raised ring to provide a hermetic seal between the upper and lower plate.

### BRIEF DESCRIPTION OF THE FIGURES

FIG. 1 illustrates a filtration plate suitable for implementing an illustrative embodiment of the invention.

FIG. 2 is a flow chart illustrating the steps of assembling a filtration plate according to an illustrative embodiment of the invention.

FIG. 3 is a detailed perspective view of an upper well of the filtration plate of FIG. 1 during the assembly process.

FIG. 4 is a detailed side view of the well of FIG. 3 after application of a seal-promoting material.

FIG. 5 illustrates the upper well of FIG. 3 during placement of a filter media on the seal-promoting material.

FIG. 6 illustrates the upper well of FIG. 3 after final curing of the seal-promoting material to form an o-ring seal.

FIG. 7 is a flow chart illustrating a method of assembling a filtration plate according to another embodiment of the invention.

FIG. 8 illustrates a filtration place suitable for implementing the method illustrated in FIG. 7.

FIG. 9 is a flow chart illustrating a method of assembling a filtration device using a latching mechanism according to another embodiment.

FIG. 10 illustrates an upper well and a corresponding lower well of a filtration device suitable for implementing the method shown in FIG. 9.

FIG. 11 illustrates the filtration device of FIG. 10 after placement of a filter disc on the upper well.

FIG. 12 illustrates the filtration device of FIG. 10 after placement of a sheet of filtering material over the upper well.

FIG. 13 illustrates the filtration device of FIG. 10 in an assembled state.

### DETAILED DESCRIPTION OF ILLUSTRATIVE EMBODIMENTS

In an illustrative embodiment, an improved filtration plate and method of assembling the filtration plate are provided. The filtration plate and method of assembling the filtration plate integrate a seal at an interface between an upper plate and filter media and/or a lower plate and a filter media using a seal-promoting material, which may form an O-ring upon curing of the seal-promoting material. The seal-promoting material also effectively secures the filter media to the upper and/or lower plate. The present invention will be described below relative to an illustrative embodiment. Those skilled in the art will appreciate that the present invention may be implemented in a number of different applications and embodiments and is not specifically limited in its application to the particular embodiments depicted herein.

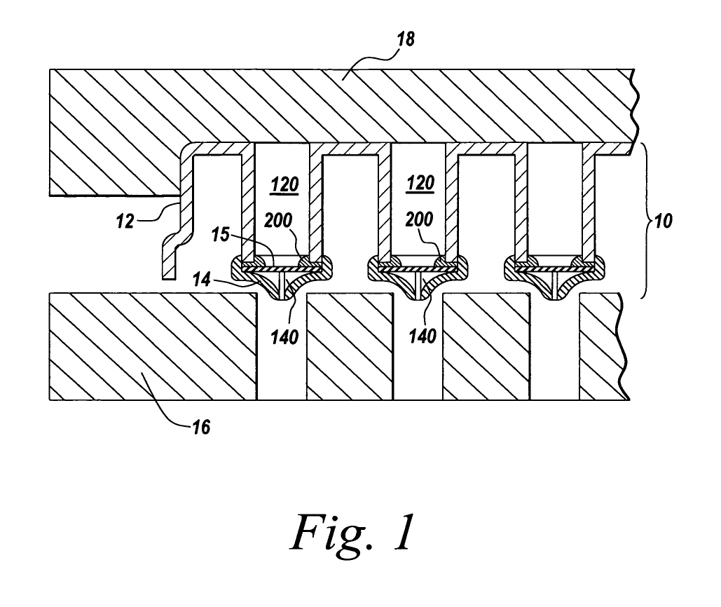

FIG. 1 illustrates a multi-well filtration plate 10 suitable for implementing an illustrative embodiment of the invention, though one skilled in the art will recognize that the invention may also be implemented in a single-well plate as well. The illustrative multi-well plate 10 includes an upper plate 12 having a plurality of apertures defining an array of upper wells 120 and a lower plate 14 coupled to the upper plate 12. According to the illustrative embodiment, the upper plate 12 and lower plate 14 are formed of a machined or molded thermoplastic material, though one skilled in the art will recognize that the plates may be formed of any suitable material. The lower plate 14 includes a single or plurality of apertures arranged to be registerable with the bottoms of the upper wells 120 of the upper tray 12. In the illustrative embodiment, the apertures of the lower plate form a plurality of lower wells 140 corresponding to the upper wells 120. Each upper well 120 is received in a corresponding lower well 140 and retained therein, though one skilled in the art will recognize that any suitable means for coupling the upper plate 12 to the lower plate 14 may be used.

The aperture of one or more of the upper wells 120 is closed at an interface with the lower plate 14 by a filter media 15, which may be entrapped between the upper plate 12 and the lower plate 14. The filter media 15 separates each lower well 140 from an associated upper well 120 for performing filtration of a substance in the upper well. According to the illustrative embodiment, the filter media comprises a plurality of filter discs, each filter disc disposed between an upper well 120 and a lower well 140. According to an alternate embodiment, the filter media 15 comprises a unitary sheet of filter or membrane material covering a plurality of wells, a plurality of membrane discs or a plurality of layers of a filter media.

The illustrative filter media 15 is a material of any suitable composition and size which may used to separate or filter substances in solution by means of unequal diffusion, e.g., by size exclusion. One skilled in the art will recognize that the filter media may be formed of any material suitable for performing filtration, including general filtration, microfiltration and ultrafiltration, reverse osmosis, separation, dialysis and other related processes Although filter media is typically are semipermeable, the term “filter media” as used herein is not so limited. The filter media is also not limited to filtration of liquid or solid samples by size exclusion, and may also be used to filter electromagnetic radiation (e.g., visible light, infrared radiation, laser and ultraviolet light) and other substances. The filter media may have any suitable size, porosity and thickness suitable for the intended application. Examples of suitable materials for forming the filter media include, but are not limited to glass, fiber, nylon, cellulose, nitrated- or phosphated cellulose, combinations of these materials, and the like.

As shown, the lower plate 14 may be mounted on a lower assembly fixture plate 16, which includes a plurality of conduits or aperture for receiving filtrate from the lower wells 140. The lower assembly fixture plate 16 structurally supports the lower plate 14 of the filtration plate 10 and maintains the well or wells of the lower plate 14 in proper alignment with the corresponding well or wells of the upper plate 12. An upper assembly fixture plate 18 may be coupled to the upper plate 12 for aligning the upper wells 120 with the lower wells 140 when the upper plate 12 and upper assembly fixture plate 18 are assembled with the lower plate 14 and the lower assembly fixture plate 16.

Applications in which the filtration plate 10 may be used typically involve the assaying of collected material utilizing methods of analysis that include, but are not limited to, liquid scintillation counting, radiography, luminometry, and the like. To perform an assay, a sample to be assayed is received in an upper well 120 of the plate 10. Filtrate is communicated through the filter media 15 at an interface between the upper well 120 and a lower well 140. At least a portion of the suspended particulate material in the sample is collected on the filter media, while the filtrate passes to the lower well. Analysis is made of either or both the collected material and the filtrate to determine the assay.

As shown, the lower well 140 receives a corresponding upper well 140 and retains the upper well by friction fit. In one embodiment, a ratcheting mechanism may be disposed on one or more of the outer walls of the upper wells 120 of the upper plate and the corresponding inner walls of the lower wells 140 of the lower plate to facilitate the engagement of the upper and lower wells and exert a constant positive pressure on the filter media. A suitable ratcheting mechanism is described in U.S. patent application Ser. No. 10/179,099, entitled “Filtration and Separation Apparatus and Method of Assembly”, contents of which are herein incorporated by reference.

In another embodiment, the interfacing surfaces of the lower plate 14 and the upper plate 12 may be provided with mating ridges and grooves, which circumscribe the juncture of each upper well and lower well to prevent cross talk between the wells 120 and 140. In the embodiment, the ridges and grooves form an interference fit between the outside diameter on the upper plate and the inside diameter of the lower plate providing a barrier that traps a filter media in the juncture of each upper well and lower well. The lower wells of the lower plate may be disposed in flexible and extendable communication with each other to allow for the fitting of the lower plate to the upper plate, thereby minimizing the need for tight manufacturing tolerances of injection molded upper and lower plates.

According to an illustrative embodiment of the invention, sealing about the perimeter of each upper or lower well is enhanced by incorporating a seal, such as an O-ring, at an interface between the upper plate and the lower plate to prevent leakage of the liquid being filtered. The seal 200 may be provided between the filter media and an upper well and/or lower well. For example, as shown in FIG. 1, the filtration plate 10 may include a series of seal rings 200 on the well perimeters defining the interfaces between the upper plate 12 and the lower plate 14. As shown, each seal ring is concentric with the corresponding upper well 120 and lower well 140. The seal rings 200 may be configured and positioned to entrap and securely hold filter media 15 of various thicknesses and layers, preventing the seepage or passage of materials around the filter media.

In the illustrative embodiment, the seal rings 200 are also used to secure the filter media or enhance the bonding between the filter media and the upper and/or lower plate of the filtration device.

One skilled in the art will recognize that the seal rings 200 may be located at any suitable position and have any suitable configuration for preventing or inhibiting leakage in the filter plate 10. In addition, a plurality of seal rings 200 may be provided for each upper and/or lower well in the filtration plate 10. The filtration plate 10 may also include a seal ring 200 on each side of the filter media at the interface between an upper and lower well.

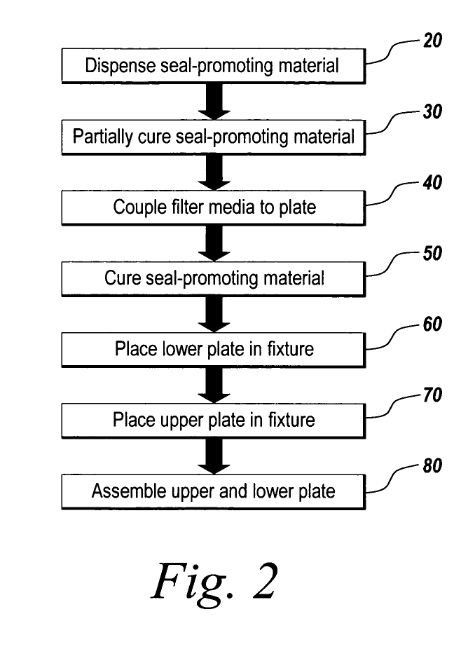

FIG. 2 is a flow chart illustrating the steps involved in assembling a filtration device, such as the filtration plate 10 of FIG. 1, according to an illustrative embodiment of the invention. The illustrative assembly method incorporates a seal-promoting material at an interface between an upper and lower plate of the filtration plate. The seal promoting material bonds the filter media to the upper and/or lower plate and forms a seal 200, for example, an O-ring, for inhibiting or prevents liquid seepage from an upper well 120, around the filter media 15, and to a lower well 140 or to another well. According to one embodiment, the assembly method utilizes an induction bonding method for assembling the upper plate 12, the filter media 15 and the lower plate 14.

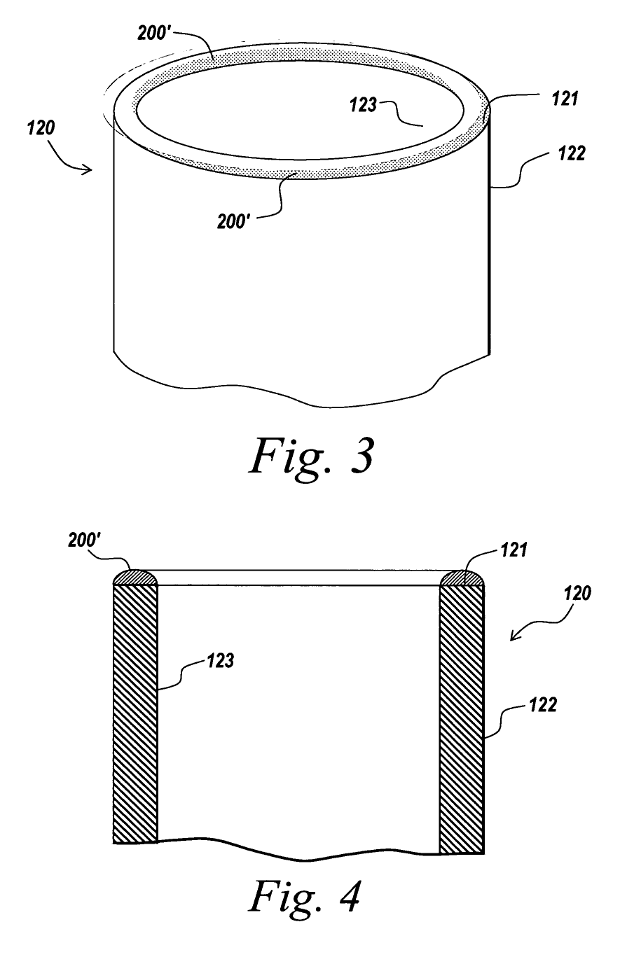

As shown in FIG. 2, a first step, step 20, comprises dispensing a seal-promoting material for forming the seal 200 to a surface forming interface between the upper plate and the lower plate, such as a surface of an upper well or a lower well or to the filter media. For example, as shown in FIGS. 3 and 4, the seal promoting material 200′, preferably in liquid form, may be dispensed about the perimeter or rim 121 of the upper well 120, which comprises a flat end surface of the side wall defining the upper well 120. According to an alternate embodiment, the seal promoting material 200′ may be applied to an outer surface 122 of the upper well side wall, the inner surface 123 of the well side wall, or any other suitable location. Alternatively, the seal-promoting material may be applied to a surface of the lower well 120, or to the filter media 15 itself. Preferably, the seal-promoting material is applied in the form of a ring, and may be dispensed on the surface of the filtration plate as a bead, line, or uniform surface.

The seal-promoting material 200′ applied in step 20 may comprise any suitable material capable of forming a seal, including, but not limited to, an adhesive, a bonding material, urethane, liquid silicone or silicone RTV. The illustrative seal-promoting material 200′ is applied in liquid form, and subsequently hardens to form the seal 200, as described below.

Conventional liquid dispensing equipment and techniques such as pad and screen printing, hot melt, aqueous spray, and other known techniques can be utilized in order to produce either uniform or patterned coat of the seal-promoting material 200′ on the selected surfaces of the components of the filtration device to be assembled.

Next, in step 30, the seal-promoting material 200′ is partially cured to form a partially cured seal-promoting material. The partial cure of the seal-promoting material increases the hardness of the material, and/or causes the seal-promoting material to gel or have an increased tackiness.

In step 40, the filter media is coupled to an upper or lower well, using the partially cured seal-promoting material to bond the filter media to a surface of the well. The filter media may be coupled manually or automatically to the selected well through means known in the art.

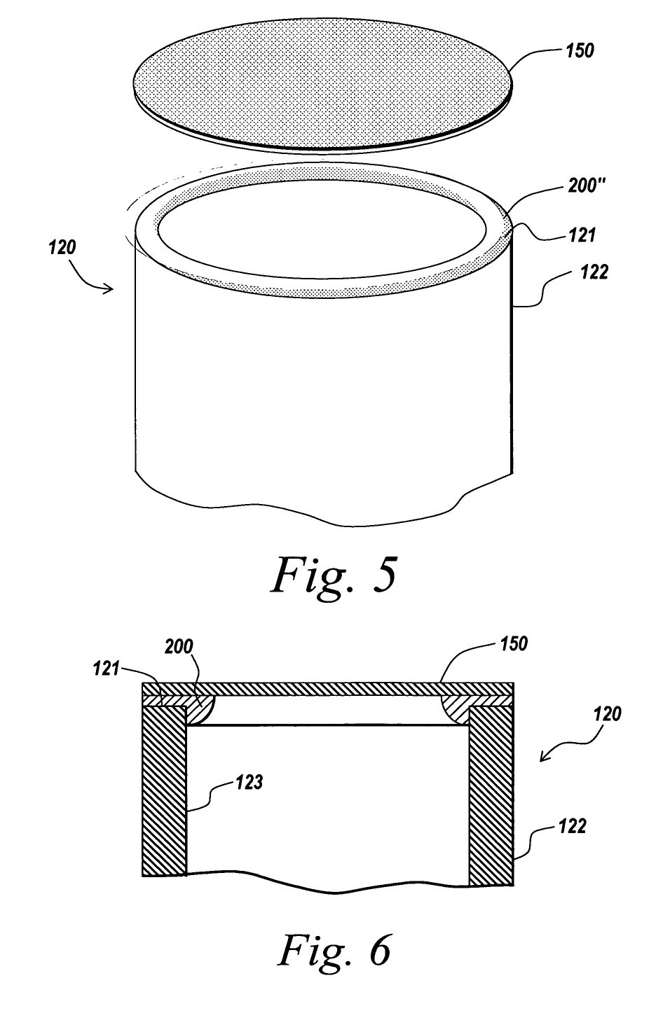

In one embodiment, shown in FIG. 5, the step 40 of coupling the filter media to a well comprises placing a filter disc 150 on the crest of the partially cured seal-promoting material 200″ on the rim 121 of the upper well 120. The seal-promoting material bonds the filter disc 150 to the surface of the well having the seal-promoting material dispensed thereon, i.e., the rim 121.

Alternatively, the filter media 15 is coupled to a lower well or wells 140 having the seal-promoting material 200″ formed thereon.

In another embodiment, the filter media 15 may comprise a sheet of a filter or membrane material, which may be coupled to a plurality of wells having the seal-promoting material 200″ dispensed thereon.

As described above, the seal-promoting material 200′ may alternatively be applied to the filter media, rather than a surface of the well. To couple the filter media to a well in step 40, the filter media having the seal-promoting material dispensed thereon moves adjacent to the selected well, such that the partially cured seal-promoting material on the filter media contacts a surface of the well, thereby bonding the filter media to the well.

Next, in step 50, the partially cured seal-promoting material 200″ undergoes a final cure to form a seal 200. According to an illustrative embodiment, the step of curing comprises thermally curing the seal-promoting material using pressure to harden the seal-promoting material. The application of pressure may also displace the seal-promoting material to achieve a fluid-tight seal at the interface between the filter media and the upper and/or lower well.

For example, as shown in FIG. 6, the final curing step performed on the partially cured seal-promoting material 200″ forms an O-ring 200 about the lower perimeter of the upper well 120. As shown, during the final cure, a portion of the seal-promoting material is flattened on the rim 121 and a portion is displaced from the rim 121 of the well 120 toward the inner surface 123 of the well, while maintaining contact with the filter disc 150 to create a fluid-tight seal at the interface between the filter disc 150 and the upper well 120. The resulting seal 200 maintains contact with the inside wall 123 of the well in the vicinity of the rim 121 and the filter disc 150 to create a strong, durable, fluid-tight seal.

After formation of the seal 200, the lower plate 14 may be placed, in step 60, into a fixture, such as the lower assembly fixture plate 16 shown in FIG. 1. As described above, the lower assembly fixture plate 16 structurally supports the lower plate, and maintains the well or wells of the lower plate in proper alignment with the upper well or wells. Next, in step 70, the upper plate 12 may be coupled to a fixture, such as the upper assembly fixture plate 18 shown in FIG. 1. As described above, the upper assembly fixture plate 18 aligns the upper wells of the upper plate 12 with the lower wells or apertures of the lower plate 14. Finally, in step 80, the upper plate 12 and the lower plate 14 are assembled, using the fixture plates to ensure proper alignment. During assembly, a substantially constant force may be applied to maintain the integrity of the seal 200 and the entrapment of the filter discs 150 between the mating surfaces of the upper and lower plate, while also maintaining the intimate contact of the seal 200 with both the associated well and the filter media.

In the embodiment shown in FIG. 1, each pair of wells includes an o-ring seal 200 formed on a lower end of an upper well between a filter disc 150 and the rim 121 of the upper well 120 and between the filter disc and the inner surface 123 of the upper well 120. One skilled in the art will recognize that an o-ring seal formed using a seal-promoting material according to the teachings of the present invention may be provided at any suitable location to provide a fluid-tight barrier between the filter media and one or both of the plates. For example, the filtration plate 10 may also include a second o-ring seal (not shown) formed on the opposite side of the filter disc 150 from the seal 200 for sealing between a surface of the lower well and the upper well and/or the filter disc.

An o-ring seal may also be provided on an outside wall 122 of an upper well 120, such that the seal contacts an inner wall of a lower well to provide a seal therebetween. In this embodiment, the inner wall of the lower well may include a groove or other suitable shape for receiving the o-ring seal.

Alternatively, or in addition to the configurations described above, an o-ring seal formed using a seal-promoting material may also be formed on an inner wall of a lower well for sealing against a surface, such as an outer wall, of an upper well 120. A seal formed on an inner wall of a lower well may align with a groove or other shape on the surface of the upper well configured to receive the seal ring.

Furthermore, though the embodiment shown in FIG. 1 illustrates the lower wells 140 receiving the upper wells 120, one skilled in the art will recognize that the lower wells 140 may alternatively have a smaller diameter than the upper wells 120, so that the upper wells receive the lower wells when the filtration plate is assembled.

In one embodiment, the lower plate 14 and the upper plate 12 include angled rings and grooves being of a ratcheting design, as described in U.S. patent application Ser. No. 10/179,099.

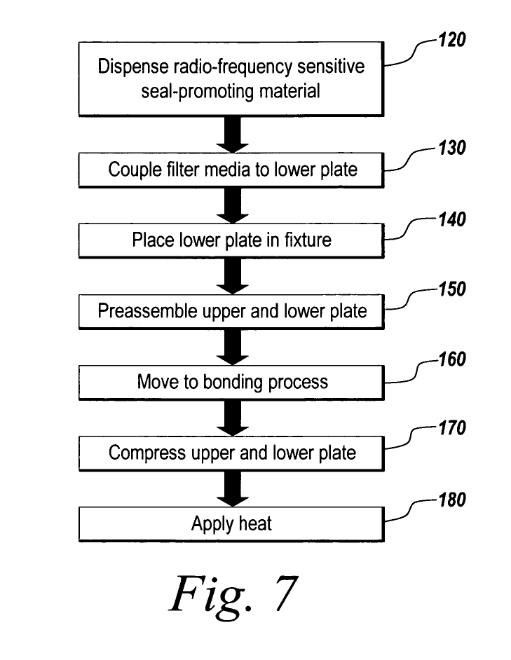

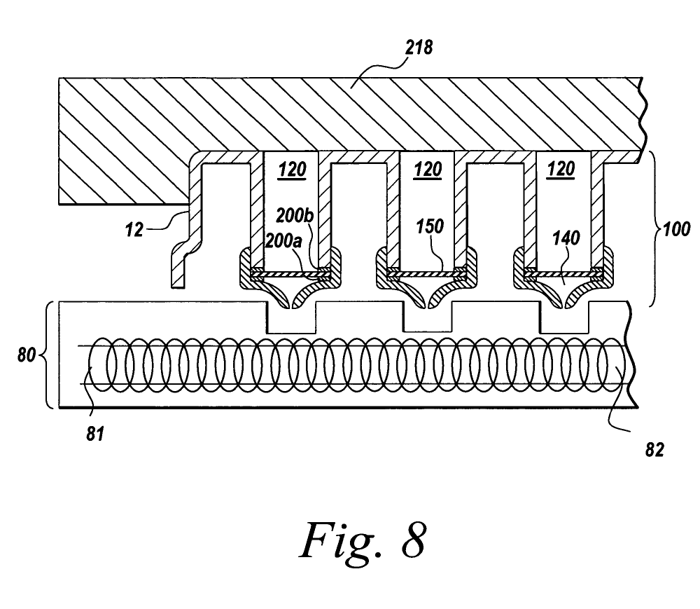

In another exemplary embodiment of the invention, a permanent hermetic seal between an upper plate 12, a filter media 15 and a lower tray 14 can be achieved by utilizing a bonding process on an radio-frequency sensitive material. FIG. 7 is a flow chart illustrating the steps involved in assembling a filtration device according to another embodiment of the invention. In the FIG. 8 illustrates a filtration plate 100 formed according to the method of FIG. 7. In the embodiment shown in FIGS. 7 and 8, the seal-promoting material comprises a radio-frequency (RF) sensitive material, which forms a first seal 200a at an interface between a lower well 140 and a filter media, illustrated as a filter disc 150, and a second seal 200b at an interface between an upper well 120 and the filter media. As shown, the seals 200a and 200b are formed on opposite sides of a filter disc 150.

In step 120, a radio frequency (RF) sensitive seal-promoting material is dispensed on a surface of the upper plate and/or the lower plate, or on each side of the filter media, using conventional liquid dispensing equipment and techniques, similar to step 20 in FIG. 2. In an illustrative embodiment, the radio frequency (RF) sensitive seal-promoting material is applied to the rim of one or more lower wells 140 of the lower plate in the form of a ring, though one skilled in the art will recognize variations for dispensing the radio frequency (RF) sensitive seal-promoting material. The radio frequency (RF) sensitive seal-promoting material is also applied to a surface, illustrated as a rim, of an upper well 120 in a similar manner.

Next, in step 130, a suitable filter media is coupled manually or automatically to an upper and/or lower plate. According to the illustrative embodiment, the filter media is coupled to the lower wells 140 of the lower plate 14, which have the radio frequency (RF) sensitive seal-promoting material dispensed thereon. The radio frequency (RF) sensitive seal-promoting material effectively bonds the filter media to the lower well.

In step 140, the lower plate, which, in the illustrative embodiment, contains the filter media bonded thereto by the seal-promoting material, is placed into a fixture properly aligned to the well or wells and structurally supporting the well or wells of the lower plate.

In step 150, the lower plate and the upper plate are preassembled to form a preassembled filtration plate, such that each upper well 120 in the upper plate 12 engages with a corresponding lower well 140 or aperture in the lower plate 14. In the illustrative embodiment, during preassembly, the seal-promoting material applied to the top well 120 bonds to the filter media coupled to the associated lower well 140 to ensure alignment and bonding of the filter media to the top well 120.

After preassembly in step 150, the preassembled filtration plate is moved, either manually or automatically, in step 160, to a bonding station 80 to perform a bonding process.

In step 170, clamping device 218 or other suitable means compresses the upper plate 12 and lower plate 14 of the preassembled filtration plate together. Subsequently or simultaneously with step 170, the bonding station 80, such as a power generator, produces an electromagnetic field, in step 180. The illustrative bonding station 80 includes an RF antenna 81 and an electromagnetic generator 82. The electromagnetic field generates heat, which causes melting of the RF-sensitive seal-promoting material, to form the seals 200a and 200b. One skilled in the art will recognize that any suitable means for promoting melting of a seal-promoting material may be used in accordance with the teachings of the invention. According to one aspect, the generated heat also melts adjacent surfaces of the lower and upper plate at the interface between each upper and lower well, thus forming a strong, reliable, fluid-tight, permanent hermetic seal between the assembled components, i.e., the upper plate 12, the filter media 15, or multiple layers of a filter media, and the lower plate 14.

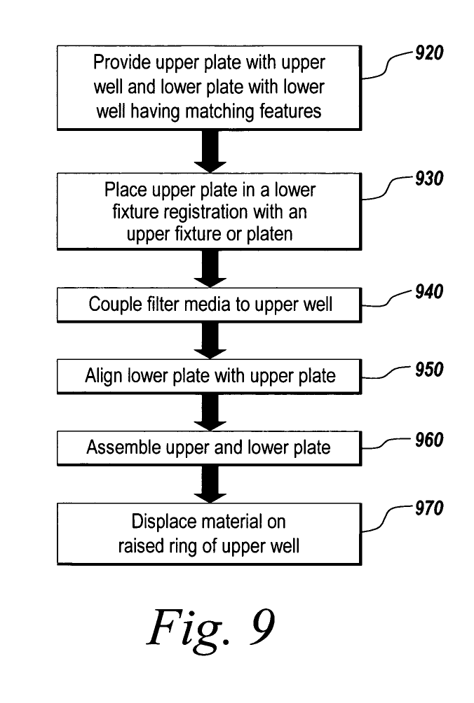

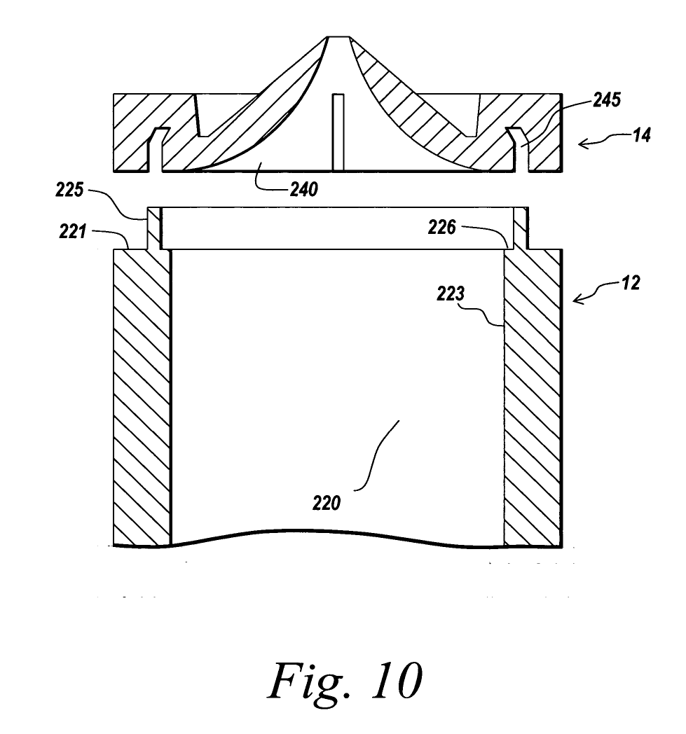

According to yet another embodiment of the invention, a hermetic seal between components of a filtration device, such as an upper plate, a filter media and a lower tray can be achieved through the mechanical assembly of the plate components and the displacement of material of the two components. FIG. 9 is a flow chart illustrating the steps involved in assembling a filtration device using a latching mechanism. FIGS. 10-13 illustrate a filtration device 200 having a latching mechanism during assembly. FIGS. 10-14 illustrate the assembly of a two-component single well device, though one skilled in the art will recognize that the system and method also apply to multi-well devices.

In step 920, an upper plate 12 with an upper well 220 and a lower plate 14 with a lower well 240 or aperture corresponding to the upper well 220 are provided. As shown in FIG. 10, the lower end of the upper well 220 includes a raised ring 225 projecting from the rim 221 of the well 220. According to the illustrative embodiment, the ring 225 is narrower in cross section than in height. The ring may be formed on a shelf 226 adjacent to the inner wall 223 of the well. The shelf 226 may be used to support a filter media, such as a filter disc. The lower well 240 of the lower plate 14 includes a matching recess 245 on an upper face 241, which is configured to receive the raised ring 225 of the upper well 220. The wells 220 and 240 may be machined, molded or fabricated using any suitable process and materials.

In step 930, the upper well 220 is placed in a lower fixture registration with an upper fixture or platen, such that the raised ring faces the upper fixture or platen.

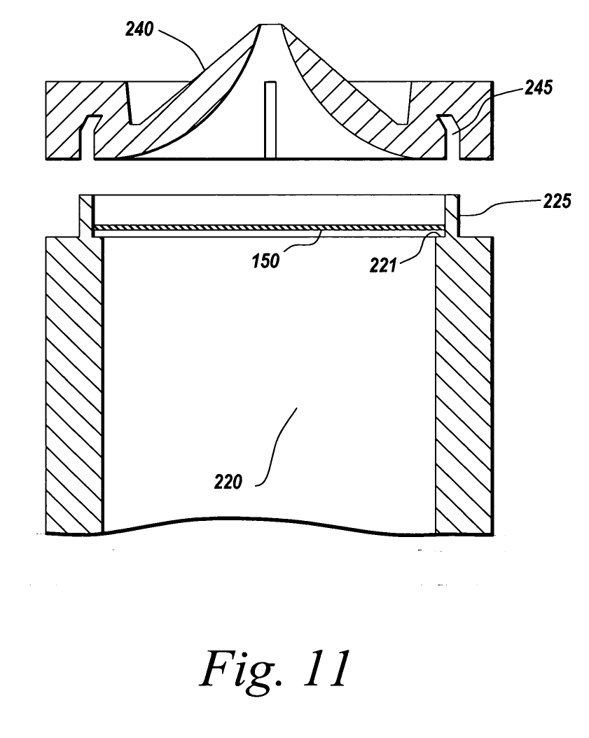

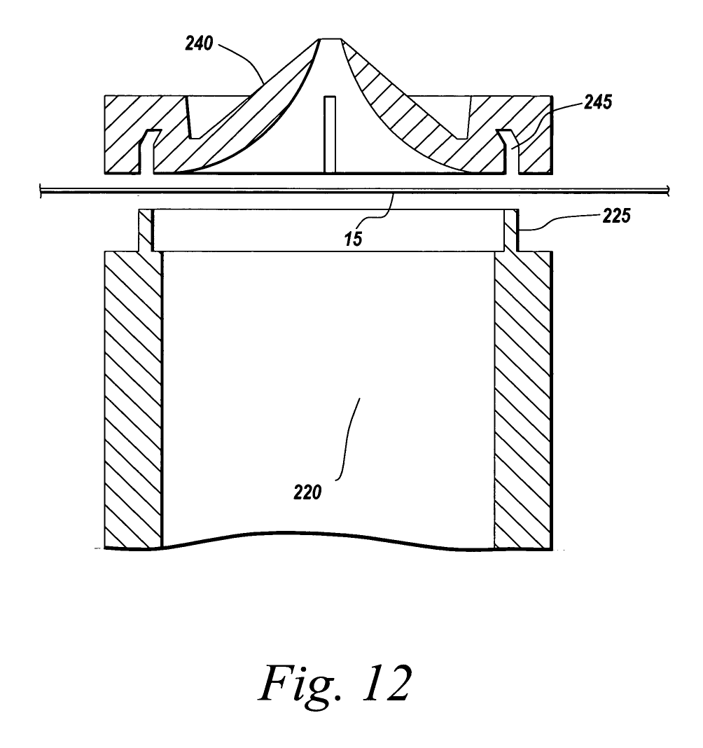

In step 940, a filter media, illustrated as a filter disc 250 is disposed, either manually or automatically on the upper well 220. According to the illustrated embodiment, as shown in FIG. 11, the filter disc 150 is placed on the shelf 226 adjacent to the raised ring 225. Alternatively, as shown in FIG. 12 a sheet of filter media 15 may be placed across the raised ring 225 of the upper well plate. In the case of a multiwell plate, the sheet of filter media 15 is placed across a plurality of raised rings 225 of multiple wells 220.

In step 950, the lower plate 14 is aligned with the upper plate 12. In the illustrative embodiment, the step of aligning comprises placing the lower plate 14 in an upper fixture or platen such that the lower well 240 or aperture of the lower plate 14 is registerable with the raised ring 225 of the upper plate 12 disposed in the lower fixture (not shown).

In step 960, the upper plate 12 and the lower plate 14 are assembled through mechanism means, for example by coupling or clamping the upper fixture and the lower fixture together. The step of assembling entraps the filter media, for example, the individual filter disc 150 between the upper well 220 and the lower well 240. When a sheet of filter media 15 is used, the step of assembling entraps the filter media by shearing the sheet of filter media into individual discs and subsequently entrapping the thus formed discs.

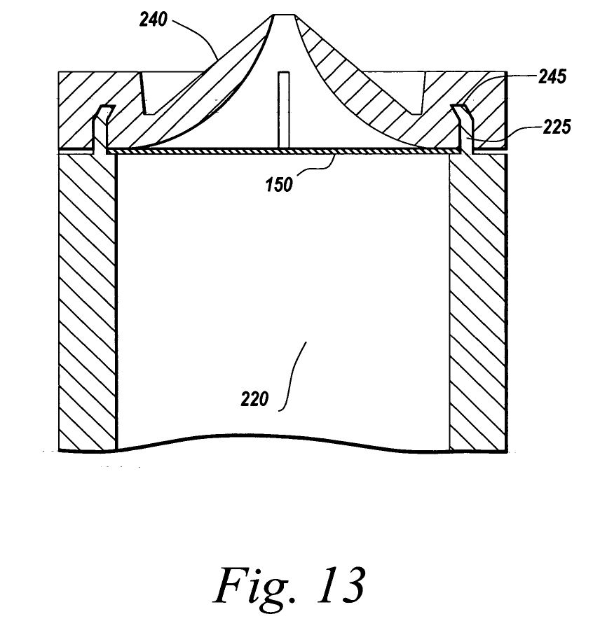

In step 970, the material forming the raised ring 225 is displaced, as shown in FIG. 13, for example, by compression of the lower well against the upper well. The full assembly and displacement of the raised ring 225 imparts force down and inward, thereby firmly entrapping the filter disc 150 between the upper and lower well. The engagement between the ring 225 and corresponding recess 245 provides a fluid-impervious barrier at the interface between the upper well and the lower well, while securing and sealing the filter disc therebetween.

One skilled in the art will recognize that the seal ring 225 and corresponding recess 246 may be angled to enhance the sealing effect and security of the fit between the filtration plate components.

In another embodiment, a raised ring may be formed on the periphery of a lower well, which corresponds to and is received by a matching recess on the upper well. One skilled in the art will recognize that the latching mechanism for coupling an upper plate to a lower plate in a filtration device is not limited to the illustrative embodiment and that any suitable mechanism for mechanically coupling an upper and lower plate to form a seal may be used.

One skilled in the art will recognize that the assembly method shown in FIGS. 9-13 may also incorporate a seal-promoting material, as described above with respect to FIGS. 1-8. The seal-promoting material may be disposed between the filter media 15 or 150, the upper well 220 and/or the lower well 240 to form a seal for preventing leakage and promoting bonding of the filter media to the upper and/or lower well. For example, a seal-promoting material may be applied in the recess 245 of the lower well, the raised ring 225 of the upper well and/or the shelf 226 of the upper well to enhance bonding and sealing of the filtration plate 200.

The illustrated method of assembling a filtration device is also applicable to single-well plates, and any other system suitable for incorporating a seal at an interface between components.

The formation of a seal, such as an o-ring seal using a seal-promoting material facilitates filtration of a substance. The permanent seal ensures that the passage of an assay shall only be through the filter media, and that particles are removed from the filtrate by the filter media. The illustrated filtration plate and assembly method has been shown to be sufficient to satisfactorily perform in assays in a large amount of micro filtration applications and/or the removal of particles 0.05 μm and larger in diameter.

The present invention has been described relative to an illustrative embodiment. Since certain changes may be made in the above constructions without departing from the scope of the invention, it is intended that all matter contained in the above description or shown in the accompanying drawings be interpreted as illustrative and not in a limiting sense. It is also to be understood that the following claims are to cover all generic and specific features of the invention described herein, and all statements of the scope of the invention, which, as a matter of language, might be said to fall therebetween.

1. A method of assembling a filtration plate, comprising the steps of:
dispensing a seal-promoting material on a first component of the filtration plate; and
curing the seal-promoting material to form a seal between the first component and a second component.

2. The method of claim 1, wherein the seal-promoting material bonds the first component to the second component.

3. The method of claim 1, wherein the first component comprises an upper well of an upper plate.

4. The method of claim 1, wherein the first component comprises a lower well of a lower plate.

5. The method of claim 1, wherein the first component comprises a filter media for filtering a substance.

6. The method of claim 1, wherein the seal-promoting material comprises one of an adhesive, bonding material, urethane, liquid silicone, silicone RTV and combinations thereof.

7. The method of claim 1, further comprising the step of displacing the seal-promoting material during the step of curing to form an o-ring seal.

8. The method of claim 1, wherein the seal-promoting material comprises an RF sensitive bonding material.

9. The method of claim 8, wherein the step of curing the seal-promoting material comprises generating an electromagnetic field to melt the bonding material.

10. The method of claim 9, wherein the electromagnetic field generates heat to melt adjacent surfaces of an upper and lower plate of the filtration plate to form a seal between the upper plate and the lower plate.

11. A method of assembling a filtration device, comprising the steps of:
dispensing a seal-promoting material on a surface of a first well formed in a first plate; and
applying a filter media to the seal-promoting material to bond the filter media to the surface.

12. The method of claim 11, further comprising the step of:
curing the seal-promoting material to form a seal between the filter media and the first well.

13. The method of claim 11, further comprising the step of partially curing the seal-promoting material prior to the step of applying the filter media.

14. The method of claim 11, wherein the step of dispensing comprises forming a ring of the seal-promoting material on a perimeter of the first well.

15. The method of claim 14, further comprising the step of heating and displacing the seal-promoting material to form an o-ring seal between the perimeter of the first well and the filter media.

16. The method of claim 11, further comprising the step of assembling the first plate with a second plate, such that the first well aligns with a second well on the second plate and is separated from the second well by the filter media.

17. A method of assembling a filtration plate, comprising the steps of:
applying a filter media to a first well of a first plate having a raised ring formed on an end of the first well; and
coupling the first plate to a second plate by inserting the raised ring into a matching recess on a second well of the second plate.

18. The method of claim 17, wherein the step of coupling traps the filter media between the first well and the second well.

19. The method of claim 17, further comprising the step of:
displacing the seal ring to secure the first plate to the second plate.

20. A method of assembling a filtration plate, comprising the steps of:
applying a seal-promoting material in the form of a ring to a well of the filtration plate;
partially curing the seal-promoting material to form a partially cured seal-promoting material;
applying a filter media to the partially cured seal-promoting material; and
thermally curing the partially cured seal-promoting material to form an o-ring seal between the filter media and the well.

21. A filtration plate, comprising:
an upper plate having an upper well;
a filtration media coupled to the upper well to form a chamber for holding a sample;
a lower plate having a lower well aligned with and separated from the upper well by the filtration media; and
a seal formed at an interface between the upper plate and the lower plate, wherein the seal is formed by a seal-promoting material.

22. The filtration plate of claim 21, wherein the seal secures the filtration media to the upper well.
